(19) United States
(12) Patent Application Publication
(10) Pub. No.: US 2004/0103853 A1
(43) Pub. Date: Jun. 3, 2004

(54) Hanging Aquarium

(76) Inventor: Dejduang Anusasananunta, Trang (TH)

Correspondence Address: Temduang Anusasananunta, 232 Cascade Rd., Pittsburgh, PA, 15221, US

(21) Appl. No.: 10/383,333

(22) Filed: Mar. 10, 2003

Related U.S. Application Data
(60) Provisional application No. 60/362,894, filed on Mar. 11, 2002.

(51) Int. Cl. A01K 63/00

(52) U.S. Cl. 119/245

(57) ABSTRACT

The invention is a fish tank comprising front and back panels, for hanging on a vertical surface. The manufacturing technique involves applying air pressure to molten material to form the panels of the fish tank into desired shapes.

### CROSS-REFERENCE TO RELATED APPLICATIONS

Provisional Patent Application No. 60/362,894. Filing date Mar. 11, 2002.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Most fish-tanks have front, back, side and bottom panels. These panels are typically made of glass and glued together with transparent or colored silicone. The top panel or cover may be made of plastic and may be designed to hold fish-tank equipment, such as lighting and oxygen supply. This kind of fish-tank is heavy and requires strong support. The fish-tank and the support may take a lot of space.

### BRIEF SUMMARY OF THE INVENTION

The invention is a fish-tank, also known as an aquarium, for hanging on a vertical surface, such as a wall or side panel of a cupboard. The front panel of the fish tank is made from transparent material such as acrylic plastic, PVC, polycarbonate or polystyrene. This front panel is formed by applying air pressure to the softened material inside a mold. The panel can be formed into many shapes, such as a hemisphere, a heart, a fish, a guitar, a diamond, etc. The front panel is then glued to the back panel, which is made of similar material. These two panels form the fish-tank. This fish-tank is lightweight and can easily be mounted on a vertical surface either directly or by hanging. A hanging fish tank saves space.

### BRIEF DESCRIPTION OF THE SEVERAL VIEWS OF THE DRAWINGS

FIG. 1 is a perspective view of the oven.

FIG. 2A is a perspective view of the front-panel mold.

FIG. 2B is a top view of the front-panel mold.

FIG. 2C is a front view of the front-panel mold.

FIG. 2D is a section view of the front-panel mold.

FIG. 3A is a top view of the front panel being molded.

FIG. 3B is a front view of the front panel being molded.

FIG. 3C is a section view of the front panel being molded.

FIG. 4 is a perspective view of the back-panel mold.

FIG. 5A is a top view of the back-panel being mold.

FIG. 5B is a front view of the back panel being molded.

FIG. 5C is a section view of the back panel being molded.

FIG. 6 is a perspective view of the front and back panels after being molded.

FIG. 7A is a top view of the fish-tank.

FIG. 7B is a front view of the fish-tank.

FIG. 7C is a side view of the fish-tank.

FIG. 7D is a section view of the fish-tank.

FIG. 8 is a perspective view of an example round fish-tank.

FIG. 9 is a perspective view of an example guitar-shaped fish-tank.

FIG. 10 is a perspective view of an example heart-shaped fish-tank.

### DETAILED DESCRIPTION OF THE MANUFACTURING PROCESS FOR THE INVENTION

In the remaining of this document, “acrylic” is used as an example of the materials that can be used for the front and the back panel.

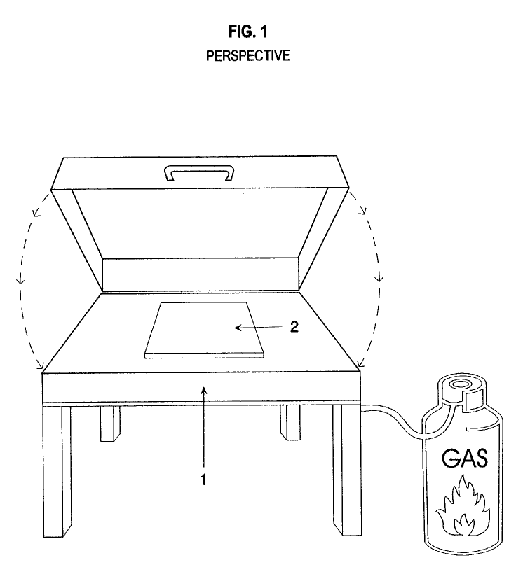

FIG. 1 shows the process of melting an acrylic sheet in a gas or electric oven 1. This process is used for both the front and the back panels. The front panel is a transparent acrylic sheet. The back panel can be a transparent, translucent or even opaque acrylic sheet. The acrylic sheet 2, which has been cut to right size, is placed in the oven after the oven reaches the right temperature. When the acrylic sheet is soft enough for the molding process, it is taken out of the oven and immediately placed in the mold.

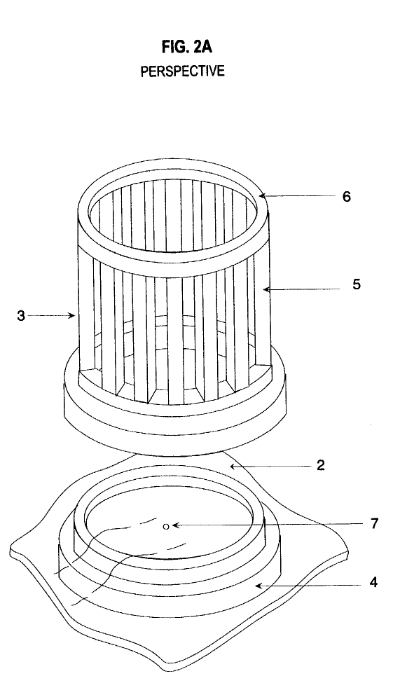

FIGS. 2A, 2B, 2C, and 2D show the front-panel mold, which consists of the female part 3 and the male part 4. The male part is placed on a flat surface and the acrylic sheet is placed between the male and the female parts. Hydraulic pressure is applied on top of side 6 of the female part to form the edges of the acrylic sheet and also to hold the sheet as air pressure is applied through the center hole 7 on the male part. The sheet is formed towards the inside of the female part, so the frame 5 of the female part has to be designed to be high enough not to obstruct the sheet as it forms. The mold can be made from wood, concrete, metal, or other materials that can be made into a strong enough mold to withstand the hydraulic pressure.

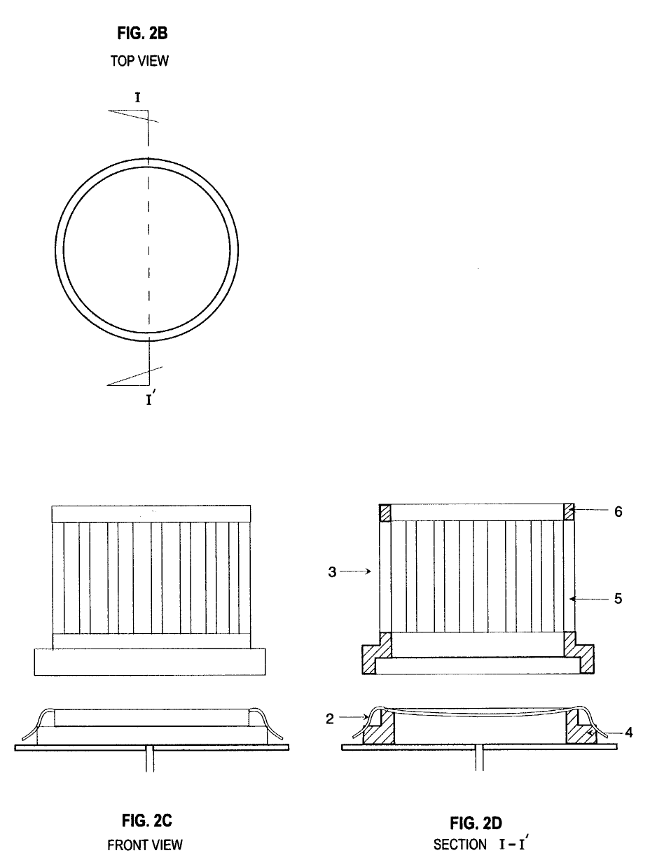

FIGS. 3A, 3B, and 3C show the process of making the front panel. The molten acrylic sheet is placed in between the male 3 and female 4 parts of the front-panel mold. While hydraulic pressure 8 is applied on the top of the female part, air is blown through the center tube 9 of the male part. The air pressure causes the acrylic sheet to form freely inside the female part. When the acrylic sheet forms into the right size, the air pressure is maintained at a constant level until the acrylic sheet cools down to become firm. Then the hydraulic and air pressures are removed. The acrylic sheet 10 can now be taken out of the mold to become the front panel.

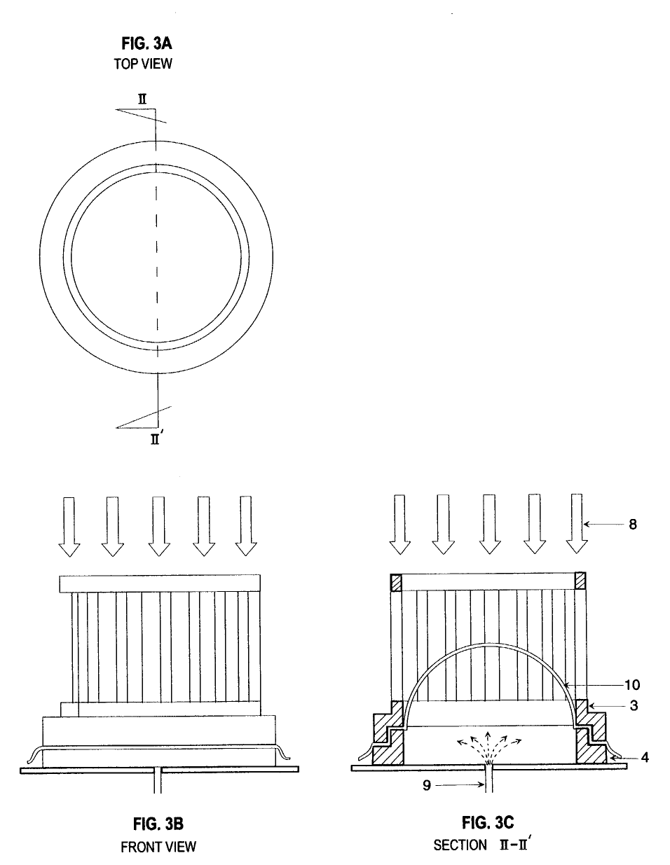

FIG. 4 shows the back-panel mold, which consists of the female part 11 and the male part 12. The mold is used with hydraulic pressure, but no air pressure, to form the back panel. Similar to the front panel, this mold can be made from wood, concrete, metal, or other materials that can be made into a strong enough mold to withstand the hydraulic pressure.

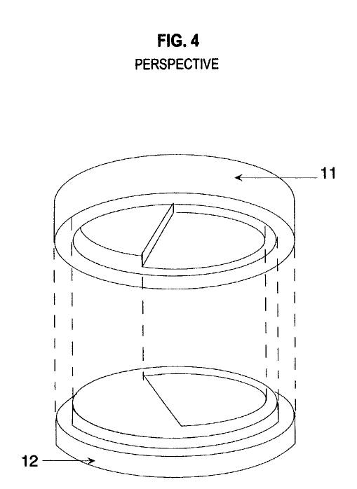

FIGS. 5A, 5B, and 5C show the process of making the back panel. The back panel material can be transparent, translucent, opaque, or printed acrylic sheet. The molten acrylic sheet is placed in between the female 11 and the male 12 parts of the back-panel mold. Hydraulic pressure 8 is applied on the female part until the acrylic sheet cools down to become firm. Then the hydraulic pressure is removed and the acrylic sheet 13 can be taken out of the mold to become the back panel. The back panel can be decorated by painting or stickers.

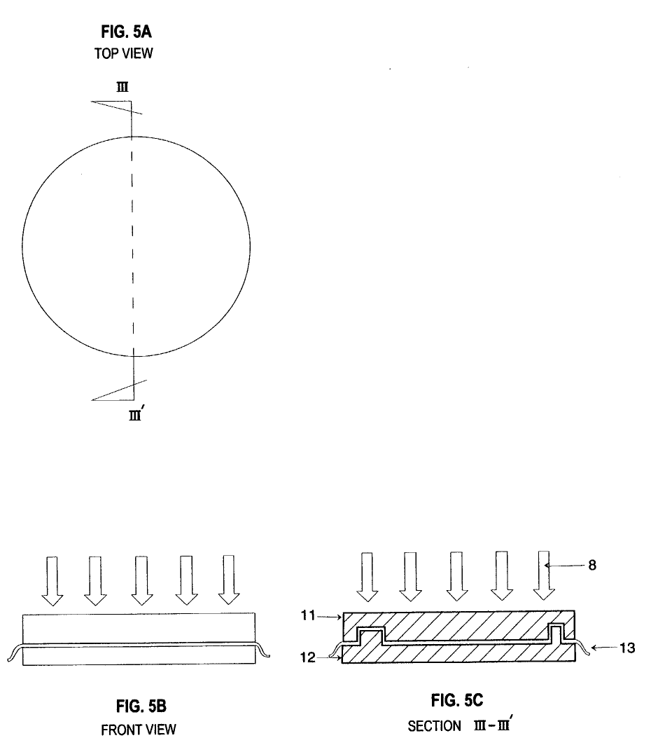

FIG. 6 shows the process of assembling the fish-tank. The front panel 10 and the back panel 13 are cut out from the acrylic sheets and the extra pieces 14 are discarded. An opening 15 is cut out on the front panel. This opening is used to put water, fish and decorations in and out of the fish-tank, so it should be cut sufficiently large. A rectangular opening 16 is cut out on the back panel. The opening allows in light from the lamp, which is mounted behind the back-panel. An oxygen tube can also be passed through this opening. Finally, the front and the back panels are glued together with silicone or any other glue that can hold the panels together without water leaking. The assembly becomes the water reservoir.

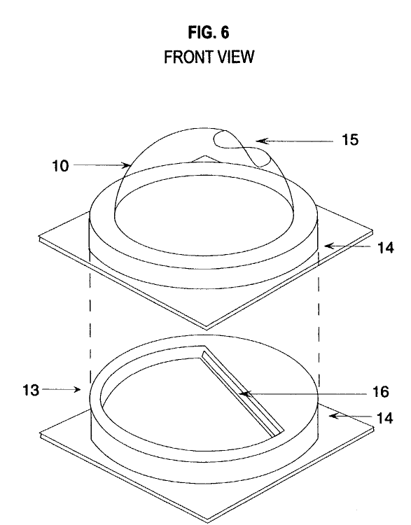

FIGS. 7A, 7B, 7C, and 7D show the assembled fish tank. A frame 17, which can be metal or any other strong material, is attached to the back of the fish-tank by metal fasteners. The frame can be designed for attaching equipment, such as a neon light 19 or an oxygen supply 20, to the fish tank, as well as supporting the fish tank when hung on a support through the hole 18 on the frame.

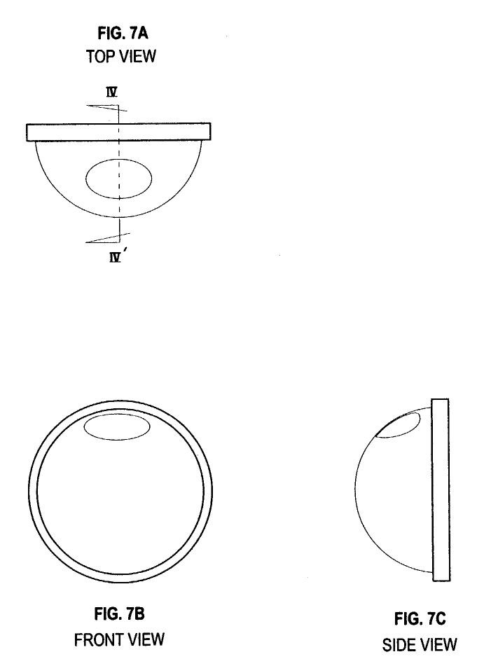

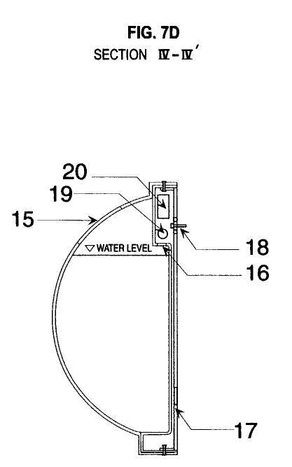

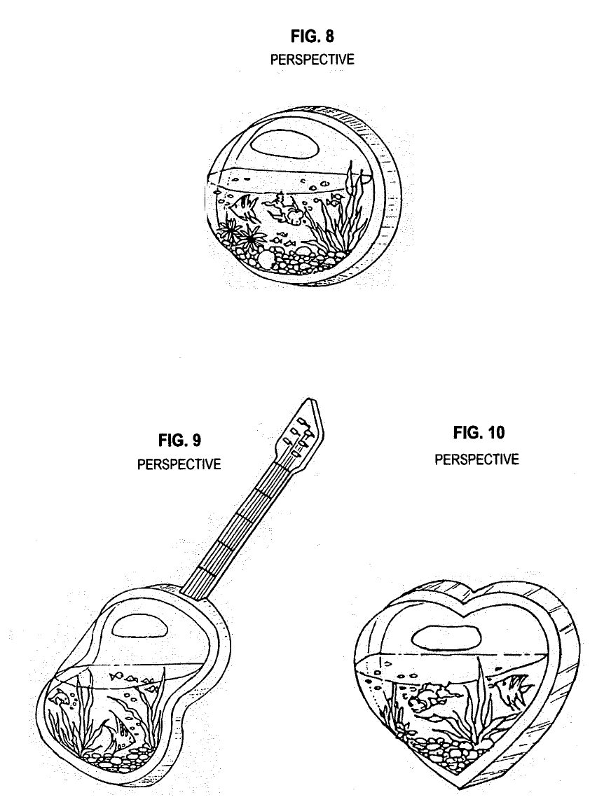

FIGS. 8, 9, and 10 show example designs for the fish-tank. Each design requires specially shaped molds, but the manufacturing techniques and materials remain the same. This document uses the circular design in the drawings for ease of presentation and understanding.

The advantages of this Invention over traditional fish-tanks are: The Invention saves space, as it does not require a stand. The manufacturing technique gives artistic freedom when designing the shape of the fish-tank. The fish-tank is easy to clean because the fish-tank is light-weight, once the water is taken out, and can easily be carried.

I claim:

1. A hanging aquarium comprising a lightweight molded front panel and a lightweight molded back panel, gluing the front-panel and back-panel together to make the aquarium.

2. A frame attached on the back-panel for holding accessories and hanging the aquarium of claim 1.

3. A suitable opening of the front panel of claim 1 to provide an access to the space inside the aquarium.

4. The process of manufacturing of claim 1, applying air pressure to a molten sheet of suitable material inside a mold to form front and back panels into desired shape.
